(19) United States
(12) Patent Application Publication
(10) Pub. No.: US 2021/0035151 A1
(43) Pub. Date: Feb. 4, 2021

(54) AUDIENCE EXPANSION USING ATTENTION EVENTS

(71) Applicant: Microsoft Technology Licensing, LLC, Redmond, WA (US)

(72) Inventors: Liu Yang, Sunnyvale, CA (US); David Pardoe, Mountain View, CA (US); Ruoyan Wang, Sunnyvale, CA (US); Onkar A. Dalal, Santa Clara, CA (US)

(21) Appl. No.: 16/527,694

(22) Filed: Jul. 31, 2019

(51) Int. Cl. G06Q 30/02; G06N 20/00

(52) U.S. Cl. CPC G06Q 30/0243; G06N 20/00; G06Q 30/0277; G06Q 30/0275; G06Q 30/0246

(57) ABSTRACT

Techniques for using attention events for audience expansion are provided. In one technique, first interaction data that indicates multiple interactions by the first entity with multiple content items is stored. The interactions includes an interaction that is based on an amount of time that content within one of the content items was presented to the first entity. Based on the first interaction data, similarity data that identifies one or more content delivery campaigns that are similar to a particular content delivery campaign is generated. Second interaction data that indicates interaction(s) by a second entity with content item(s) is stored. Based on the second interaction data and the similarity data, association data that associates the second entity with the particular content delivery campaign is stored. The association data may be used to identify the particular campaign in response to receiving a content request from a computing device of the second entity.

### TECHNICAL FIELD

The present disclosure relates to electronic content item delivery and, more particularly, to efficiently expanding a target audience in a scalable way.

### BACKGROUND

The Internet has enabled the delivery of electronic content to billions of people. The Internet allows end-users operating computing devices to request content from many different sources (e.g., websites). Some content providers desire to send additional content items to users who visit those sources or who otherwise interact with the content providers. To do so, content providers may rely on a content delivery service that delivers the additional content items to computing devices of such users. In one approach, a content provider provides, to the content delivery service, data that indicates one or more user attributes that users must satisfy in order to receive the additional content items. The content delivery service creates a content delivery campaign that includes the data and is intended for sending additional content items to computing devices of users who will visit one or more websites.

One problem that arises in content delivery is target audience size. The set of users that satisfy the targeting criteria of a content delivery campaign is referred to as the target audience. Too often the size of a target audience is relatively small. In order to reach a goal pertaining to impressions, clicks, or other types of engagement, the target audience should be a certain size, depending on one or more factors that may be unique to the content delivery campaign.

One approach to expanding a target audience of a content delivery campaign is to compare the targeting criteria of the campaign with profile attributes of each user of multiple (e.g., registered or known) users to generate a match score. The users with the highest match scores would be added to the target audience. However, given a user base of potentially tens or hundreds of millions of users, performing such a comparison for each content delivery campaign of potentially tens of thousands of campaigns that could benefit from audience expansion would require a significant amount of computing resources (e.g., CPUs and memory) and time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for distributing content items to one or more end-users, in an embodiment;

FIG. 2 is a block diagram that depicts an example system for expanding a target audience of a content delivery campaign, in an embodiment;

FIG. 3 is a flow diagram that depicts a process for expanding an audience of a content delivery campaign, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for expanding a target audience of one or more content delivery campaigns using attention events are provided. In one technique, attention events are generated based on online activity and stored. An attention event may be one of multiple types of user attention, such as a click on a content item, viewing a content item for a certain amount of time, or watching a video for a particular amount of time. The attention events are analyzed to identify campaigns that are similar. A similar pair of campaigns are used (e.g., in conjunction with a portion of the attention events) to identify a candidate set of user-campaign pairs, at least some of which are used to expand the target audience of one or more content delivery campaigns.

Embodiments disclosed herein improve computer technology, namely online content delivery systems that distribute electronic content over one or more computer networks. Embodiments reduce the time to expand a target audience of individual content delivery campaigns by avoiding the analysis of each potential entity (or user) in an entity base for each candidate campaign. Additionally, embodiments allow for the identification of similar campaigns without relying solely on clicks, which are relatively few in number and are not the sole signal for user interest or engagement. Thus, the size of the expandable target audience increases, along with the quality thereof, since there are more quality candidate users to consider for many content delivery campaigns.

### Content Distribution System

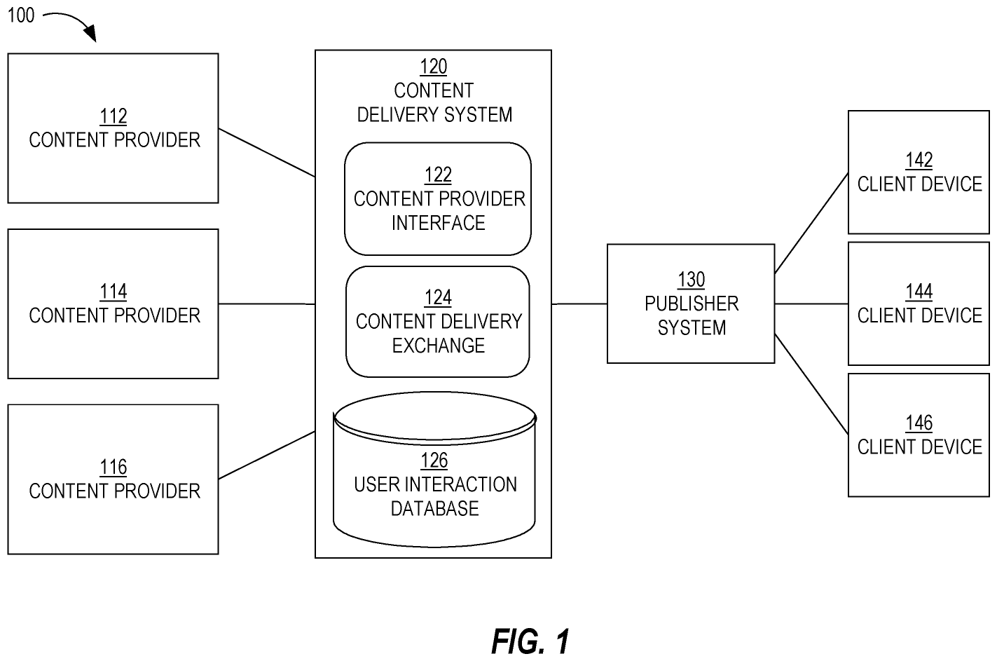

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual users.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or an interaction data set. Thus, content delivery system 120 may include a user interaction database 126. Logging such events allows content delivery system 120 to track how well different content items and/or campaigns perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery campaign (or multiple content items from the same content delivery campaign), content delivery system 120 may calculate a user interaction rate for the content delivery campaign. Additionally, from interaction data items and impression data items associated with a content provider (or content items from different content delivery campaigns initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

### Audience Expansion System

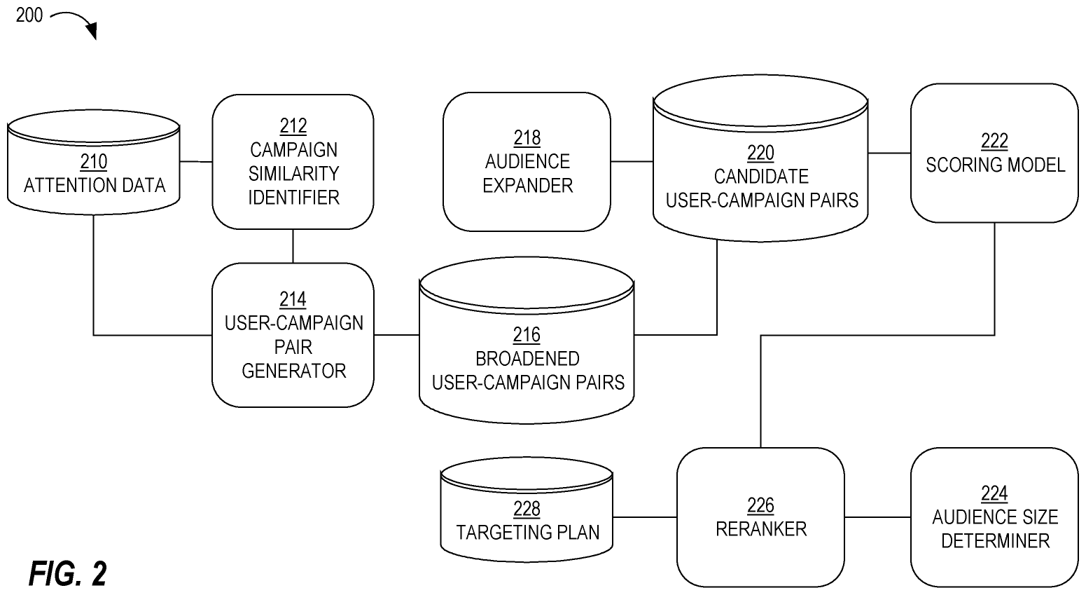

FIG. 2 is a block diagram that depicts an example system 200 for expanding a target audience of a content delivery campaign, in an embodiment. System 200 includes attention data 210, campaign similarity identifier 212, user-campaign pair generator 214, broadened user-campaign pairs 216, audience expander 218, candidate user-campaign pairs 220, scoring model 222, audience size determiner 224, reranker 226, and targeting plan 228. Each of campaign similarity identifier 212, user-campaign pair generator 214, audience expander 218, scoring model 222, audience size determiner 224, and reranker 226 is implemented in software, hardware, or any combination of software and hardware. These functional components or elements of system 200 may be implemented on a separate computing device or on any combination of two or more computing devices. For example, multiple implementations or instances of these functional elements may be distributed among multiple computing devices, acting on different sets of data. Additionally, these functional elements may be part of the same program or any combination of two or more programs.

### Attention Data

Attention data 210 (or interaction data) includes attention events or events that indicate active interactions (e.g., clicks) or inactive interactions (e.g., views) by users of, or with respect to, content items. Attention events may be generated by client devices operated by different users (e.g., client devices 142-146) and transmitted to content delivery system 120 (or an associated system). Additionally or alternatively, attention events may be generated by content delivery system 120 (or an associated system) based on other events generated by the client devices. Attention data 210 may be a subset of user interaction database 126 or may be generated based on records stored in user interaction database 126.

Each attention event indicates that a user was attentive, at least to some degree, to a content item. A content item may include text, images, audio, graphics, video, or any combination thereof. Thus, an attention event identifies a user (e.g., a user or member identifier) and a content item (e.g., using a content item identifier, which may include or encode an identifier of a campaign to which the content item belongs). An attention event may also include a timestamp that indicates when the attention occurred, such as a date, a day of the week, and/or a time of the day.

An attention event may also indicate a type of attention. Example types of attention include a user click on a content item, a user being presented with at least a portion (and not the entirety) of video of a content item (referred to as a “partial video view”), a user being presented with a (e.g., non-video) content item for a particular period of time or for a minimum period of time (e.g., five seconds), referred to as “impression duration.”

A user selection of (or “click” on) a content item may involve selecting an image or selectable text of the content. An example of “selecting” a content item include placing a finger on portion of a touchscreen that displays the content item. Another example of “selecting” a content item is pressing a physical button of a cursor control device (or “mouse”) while a digital cursor (controlled by the cursor control device) on a screen is placed over the content item. Selection of a content item may result in a user's browser being directed to another webpage, such as a third-party webpage, such as a webpage provided by a content provider that created or initiated the selected (or “clicked”) content item. Alternatively, the webpage may be another webpage hosted by publisher system 130, through which the selected content item is being presented.

A user may interact with a content item in other ways, other than selecting the content item. For example, a content item may be associated with digital elements or controls that are adjacent to the content item. Such elements may be provided by content delivery system 120 and may be used with other content items of the same type. For example, a content item may be a paginated electronic document that a user to whom the content item is presented may scroll through pages of the document using forward and backward arrows that are displayed adjacent to the document. As another example, digital elements adjacent to many (or all) content items provided from content delivery system 120 include a “like” button, a “share” button, and/or a “comment” button. Selection of such buttons are public actions that act as signals that content delivery system 120 (or publisher system 130) may use to determine what to display to the user in the future and/or what to display to other users, such as users that are connected to the user in an online social network.

Regarding a partial video view type of attention, the amount of time that a video is presented on a client device of a user is used to determine whether an attention event occurred. A threshold presentation time may be defined such that only presentation times greater than a certain amount will result in generation of an attention event. For example, 10 seconds of presentation of a video may be a minimum threshold before an attention event is generated. Instead of video presentation time, a percentage of a video presented is defined such that an attention event will be generated. For example, 75% of a video must be presented (regardless of the total length of the video) in order for an attention event to be generated.

Regarding impression duration type of attention, the length of presentation (or “presentation period”) of a content item to a user may be determined based on how long at least a certain portion or percentage of the content item is presented to the user through a viewport. For example, if 50% of a content item is presented, then a start presentation event is generated that identifies the content item and if 50% of the content item is no longer presented or visible, then an end presentation event is generated. By differencing the times of the two events, a presentation period may be determined. If the presentation period is greater than a particular threshold, then it is presumed that the corresponding user paid attention to the corresponding content item.

In a related embodiment, an attention event is generated for each partial video view event or impression duration event, regardless of the length of presentation. In such an embodiment, the attention event may indicate the presentation length (in the case of impression duration events and partial video view events) or presentation percentage (in the case of partial video view events). In this way, a downstream process that analyzes attention events may take into account the presentation length/percentage when determining whether to use the attention event in calculating campaign similarity, which is described in more detail herein.

It is presumed that a user views a content item (or content thereof) that is presented to the user, but such a presumption may turn out to be incorrect from event to event. In other words, even though a content item is presented on a user's computing device (e.g., client device 142), the user may be viewing or paying attention to something else.

Attention events that are stored in attention data 210 may be limited to events that occurred within a particular time in the past, such as the last thirty days. Thus, “old” attention events may be continuously deleted or aged out of attention data 210 while new attention events are continually being added to attention data 210. Alternatively, there may be no age restriction on the attention events in attention data 210.

While attention data 210 is depicted as being part of a single storage medium, attention data 210 may be stored across multiple storage media, whether volatile or non-volatile.

### Campaign Similarity

Campaign similarity identifier 212 takes attention events as input and outputs pairs of content delivery campaigns that are determined to be similar. Campaign similarity identifier 212 determines that two content delivery campaigns are similar based on multiple attention events, each individually pertaining to one of the two campaigns. If multiple users pay attention to two content delivery campaigns, then it is presumed that the two content delivery campaigns are similar. For example, 30% of all users identified in attention events pertaining to campaign A are also identified in attention events pertaining to campaign B. Thus, one set of users paid attention to both campaigns A and B. However, if those users only represent a relatively small percentage of the users identified in attention events pertaining to campaign B (e.g., under 5%), then campaigns A and B might not be identified as similar. Instead or in addition to percentage, there may be thresholds on the number of users in each group.

One example technique to measure similarity between two content delivery campaigns based on pairs of attention events is Jaccard similarity. A Jaccard index is defined as (|A ∩ B|)/(|A|−|B|−|A ∩ B|), where |A| is the number of users that paid attention to campaign A (as indicated in attention data 210), |B| is the number of users that paid attention to campaign B (as indicated in attention data 210), and |A ∩ B| is the number of users that paid attention to both campaign A and campaign B. A related similarity measure is Jaccard distance and is defined as (|A U B|−|A ∩ B|)/(|A U B|), where |A U B| is the number of users that paid attention to campaign A or campaign B.

Another example similarity measure is cosine similarity. To illustrate the differences between cosine similarity and Jaccard similarity, the following example and notations are provided. User uᵢ paid attention to campaign cⱼ for rᵢⱼ times, where i=1, 2, . . . N. Cosine similarity of two campaigns cⱼ, cₖ is defined as Sim_{C}(cⱼ, cₖ)=(Σᵢ₌₁(rᵢⱼriₖ))/(Σi=1(rᵢⱼrᵢⱼ))(Σᵢ₌₁(rᵢₖrᵢₖ)))^{1/2}.

Jaccard similarity of two campaigns cj, ck is defined as Sim_{J}(cⱼ,cₖ)=(Σᵢ₌₁(1(rᵢⱼ)1(rᵢₖ))/(Σᵢ₌₁[1−0(rᵢⱼ)0(rᵢₖ)]), where 1(x)=1 for x>0; 1(x)=0 for x=0; 0(x)=1−1(x).

One difference brought by Jaccard similarity is that it normalizes the attention count between member and campaign to be binary and reduces the impact of those that pay attention to many content items (e.g., “clickers”).

In an example scenario, there are 3 campaigns, 10 users. Each user's attention count to each campaign (or the number of times each user paid attention to a content item of the campaign) is indicated in the table below.

| | u₁ | u₂ | u₃ | u₄ | u₅ | u₆ | u₇ | u₈ | u₉ | u₁₀ |
|---|---|---|---|---|---|---|---|---|---|---|
| c₁ | 1 | 1 | 1 | 1 | 1 | 1 | 1 | 1 | 1 | 10 |
| c₂ | 1 | 1 | 1 | 1 | 1 | 1 | 1 | 1 | 1 | 1 |
| c₃ | 0 | 0 | 0 | 0 | 0 | 1 | 1 | 1 | 1 | 10 |

With cosine similarity, Sim_{C}(c₁,c₂)=0.58 and Sim_{C}(c₁,c₃)=0.98. These similarity values show that u₁₀'s attention instances dominates the similarity value.

With Jaccard similarity, Sim_{J}(c₁,c₂)=1.0 and Sim_{J}(c₁,c₃)=0.5, which reflects the co-attention events of the majority of users.

In a related embodiment, campaign similarity may be a one-way similarity and not a two-way similarity. For example, if 50% of users that paid attention to campaign A also paid attention to campaign B, but only 2% of users that paid attention to campaign B also paid attention to campaign A, then campaign similarity identifier 212 may determine that campaign B is similar to campaign A but that campaign A is not similar to campaign B.

### Campaign Similarity—Time Discount

In an embodiment, time lapse between two attention events is a factor in determining similarity between two content delivery campaigns. For example, a first attention pair indicating that a first user paid attention to a content item from campaign B ten minutes after paying attention to a content item from campaign A will have a higher weight than a second attention pair indicating that a second user paid attention to a content item from campaign D two weeks after paying attention to a content item from campaign C.

In a related embodiment, a threshold time lapse is defined such that if two attention events (of the same user pertaining to different campaigns) occurred greater than a certain time lapse threshold (e.g., 14 days), that attention pair will not be used as a positive sample and, thus, will not be used to determine a number of users that paid attention to content items from the two different campaigns.

### Campaign Similarity—Attention Type

In an embodiment, the type of attention is considered when determining campaign similarity. For example, the overlap of users of click events pertaining to a pair of campaigns is considered independently of the overlap of users of video view time pertaining to the same pair of campaigns. Thus, the pair of campaigns may be determined to be similar using the click events but not the video view time events.

In a related embodiment, the type of attention is not considered when determining campaign similarity. For example, the overlap of users of attention events (regardless of attention type) pertaining to a pair of campaigns is considered when determining whether the pair of campaigns is similar. As a specific example, a first user clicked on a content item from campaign A (as indicated in one attention event) and viewed a content item from campaign B for more than nine seconds (as indicated in another attention event). These two events are used to determine whether campaigns A and B are similar. As another specific example, a second user clicked on a content item from campaign C and clicked on a content item from campaign D, while a third user viewed a video of the content item from campaign C for fifteen seconds and viewed a video of the content item from campaign D for twenty seconds. These two sets of attention events are used to determine whether campaigns C and D are similar.

### Campaign Similarity—Filter

In an embodiment, a pair of campaigns that is identified as similar is filtered out if it is determined that neither campaign in the pair is associated with audience expansion. A content delivery campaign is associated with audience expansion if audience expansion has been enabled for that campaign. Input from a content provider that created the content delivery campaign may be required to enable audience expansion. Alternatively, audience expansion may be automatically enabled for a content delivery campaign (e.g., by content delivery system) if it is determined that the content delivery campaign is not meeting certain goals and/or if the size of the target audience is relatively small or smaller than a threshold number given the size of the budget of the campaign and, optionally, the bid or bid range of the campaign. A “filtered-out” pair is not used to create one or more user-campaign pairs for broadened user-campaign pairs 216.

In the embodiment where a first campaign of a campaign pair is determined to be similar to a second campaign of the campaign pair but not vice versa, if the second campaign is not associated with audience expansion, then this campaign pair is filtered out and not used to create one or more user-campaign pairs for broadened user-campaign pairs 216.

The filtering step may be applied before campaign similarity identifier 212 analyzes attention events pertaining to two different campaigns. For example, if two content delivery campaigns are not associated with audience expansion, then campaign similarity identifier 212 will not consider attention events pertaining to those two campaigns.

### User-Campaign Pair Generator

User-campaign pair generator 214 generates broadened user-campaign pairs 216, where each pair associates a single user with a single campaign. User-campaign pair generator 214 generates broadened user-campaign pairs 216 based on attention events from attention data 210 and campaign similarity pairs output by campaign similarity identifier 212. (Users identified in some attention events might not be identified in any other attention event.) For example, a user viewed a content item from campaign A for over ten seconds, causing an attention event to be generated and added to attention data 210. Campaign similarity identifier 212 determines that campaign A is similar to campaign B. Thus, the user is associated with campaign B and a user-campaign record identifying this pair is generated and added to broadened user-campaign pairs 216, which may initially be empty.

### Audience Expander

Audience expander 218 uses one or more techniques other than the campaign similarity technique described herein to generate user-campaign pairs. For example, audience expander 218 may identify users of a target audience of campaign A that is associated with audience expansion and identify, for each such user, zero or more other users that are similar to the user, such as users that share a threshold number of profile attributes in common. Such users are then candidates for audience expansion for campaign A. Audience expander 218 generates a user-campaign pair for each identified candidate and adds the pair to candidate user-campaign pairs 220. In an alternative embodiment, audience expander 218 is not implemented and broadened user-campaign pairs 216 become candidate user-campaign pairs 220.

Candidate user-campaign pairs 220 represents a union of the pairs from broadened user-campaign pairs 216 and pairs generated by audience expander 218. Candidate user-campaign pairs 220 are input to scoring model 222.

### Scoring Model

Scoring model 222 generates an affinity score for each user-campaign pair. Features upon which scoring model 222 are based may include user features, campaign features, and cross user-campaign features. Example user features include user profile features (e.g., job title, job seniority, job industry, employer, skills, degree, academic institution attended), number of connections, level of engagement, and historical online behavior. Level of engagement may be a combination of engagement type and engagement lapse, such as video view time and impression/presentation time. Historical online behavior may include user engagement to organic content or other types of content, including entities (e.g., companies and users).

Example campaign features include industry associated with the campaign or the campaign's content provider, a content item type (e.g., video, image only, text only, image-text combination), pricing model (e.g., CPC, CPM, CPA), and targeting criteria.

An example cross user-campaign feature includes a level of match between targeting criteria of a campaign and profile attributes of a user. Different profile attributes may be associated with different weights. For example, a matching job title may have a higher weight than a matching skill. Another example cross user-campaign feature includes whether a user and a content provider of the campaign are in the same industry.

Scoring model 222 may be a rule-based model or a machine-learned model. In the embodiment where scoring model 222 is a rule-based model, rules may be established that count certain activities and certain profile attributes for each user, each count corresponding to a different score and, based on a combined score, determine whether the user might have an affinity to a certain content delivery campaign.

Rules may be determined manually by analyzing characteristics of users and characteristics of campaigns whose content items the users interacted with (or not). For example, it may be determined that 10% of users in the information technology industry paid attention to content items from content providers associated with the information technology industry.

A rule-based scoring model has numerous disadvantages. One disadvantage is that it fails to capture nonlinear correlations. In addition, complex interactions of features cannot be represented by such rule-based prediction models.

Another issue with a rule-based scoring model is that the hand-selection of values is error-prone, time consuming, and non-probabilistic. Hand-selection also allows for bias from potentially mistaken business logic.

A third disadvantage is that output of a rule-based scoring model is an unbounded positive or negative value. The output of a rule-based scoring model does not intuitively map to the probability of paying attention. In contrast, machine learning methods may be probabilistic and can therefore give intuitive probability scores. However, in some embodiment, a machine-learned scoring model 222 generates a non-probabilistic score.

### Machine-Learned Scoring Model

In an embodiment, scoring model 222 is generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users and regions. The statistical model is trained based on multiple attributes (or factors) described herein. In machine learning parlance, such attributes are referred to as “features.” To generate and train a statistical prediction model, a set of features is specified and a set of training data is identified.

Embodiments are not limited to any particular machine learning technique for generating scoring model 222. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned prediction models to capture non-linear correlations between features, and the reduction in bias in determining weights for different features.

A machine-learned prediction model may output different types of data or values, depending on the input features and the training data. For example, training data may comprise, for each user, multiple feature values, each corresponding to a different feature. Example features include the features described previously. In order to generate the training data, information about each user is analyzed to compute the different feature values. In this example, the label (or dependent variable) of each training instance may be whether the corresponding user paid attention to the corresponding content item. Additionally or alternatively, the label of each training instance may indicate an extent to which the corresponding user paid attention to the corresponding content item, such as a time period while the content item was presented to the user.

Initially, the number of features that are considered for training may be significant. After training a scoring model and validating the scoring model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future prediction models and making predictions.

### Generating Training Instances Based on Attention Events

In an embodiment, attention events are used to generate training instances. For example, an attention event may be used as a positive label for a training instance while an impression event that is not associated with an attention event or that is not associated with a minimum presentation time may be used as a negative label for a training instance.

As another example, a first training instance corresponding to a user selection (e.g., click) has a positive training label of 1, a second training instance corresponding to a non-selection with a presentation time greater than 6 seconds has a training label of 0.5, and a third training instance corresponding to a non-selection with a presentation time less than six seconds has a negative label (e.g., 0).

Each possible label value may be pre-assigned to a different range of presentation times. For example, for impressions where there is no corresponding user selection, a training instance with a presentation time between 2 seconds and 6 seconds is associated with a label of 0.3, a training instance with a presentation time between 6 seconds and 13 seconds is associated with a label of 0.5, and training instance with a presentation time over 13 seconds has a label of 0.8.

In a related embodiment, attention events and/or presentation time is used to modify weights of training instances. For example, if a user spends a relatively long time (e.g., one minute) viewing a content item that the user does not select (e.g., click), then a training instance based on the view is weighted higher than if the user spent a relatively short time (e.g., five seconds) viewing the content item. The presentation time of the content item may be calculated by determining a difference between a first time when at least a portion of the content item (e.g., an article, blog, video) was originally presented to the user and a second time when a certain portion (e.g., 50%) of the content item is no longer visible to the user.

A weight of a training instance reflects an importance of the training instance in the process of training scoring model 222. The higher a weight or importance that a training instance has, the more impact the training instance will have on the weights or coefficients of the machine-learned model during the training process. For example, a first training instance with a weight of two may be equivalent to having two instances of that first training instance in the training data. As another example, a first training instance with a weight of one may have twice the effect that a second training with a weight of 0.5 has on scoring model 222.

One way to incorporate presentation time in determining a weight of a training instance is to pre-assign different presentation periods with different weights, similar to the label-assignment approach described above. For example, a presentation time between 2 seconds and 6 seconds has a weight of 1.0, a presentation time between 6 seconds and 13 seconds has a weight of 1.3, and a dwell time over 13 seconds has a weight of 1.8.

### Audience Size Determiner

Audience size determiner 224 determines an audience size for each content delivery campaign of multiple content delivery campaigns. Factors that audience size determiner 224 takes into account may include a number of users that the content delivery campaign targets (or total possible audience), a (e.g., recent) visit history of users targeted by the campaign, a budget of the campaign, and/or a bid (or bid range) of the campaign. For example, a target audience of a content delivery campaign is 2,000 users, 10% of the target audience visits publisher system 130 daily, 30% visits publisher system 130 weekly, 40% visits publisher system 130 monthly, 20% visits publisher system 130 less than monthly, the budget is 1,000 units, the bid is two units, and the collective, observed click-through rate (CTR) of the target audience is 0.4%. Based on these factors, audience size determiner 224 determines that, in order to exhaust the budget in one month, the audience size needs to be 4,000 users, or double the target audience. Therefore, 2,000 more users need to be identified and added to the initial target audience of the content delivery campaign.

### Reranker

Reranker 226 ranks a set of candidate users relative to a particular content delivery campaign based on scores generated (or output by) scoring model 222 and selects a subset of the set of candidate users based on an audience size determined (or output) by audience size determiner 224. For example, if the particular content delivery campaign is determined to need 2,000 more users added to its target audience and there are 6,000 candidate users of the particular content delivery campaign, then the top 2,000 users of that 6,000 (based on score) are selected.

Based on the selected users for a content delivery campaign, reranker 226 generates a targeting plan 228 for that content delivery campaign. Targeting plan 228 is a list of “expanded” users that the content delivery campaign can target other than through the campaign's targeting criteria. Reranker 226 generates a targeting plan for each of multiple content delivery campaigns. For each user in an expanded list of a content delivery campaign, a set of expanded content delivery campaigns is updated to indicate or identify the content delivery campaign. For example, reranker 226 identifies users u1, u2, and u3 for campaign A, even though none of users u1-u3 satisfies targeting criteria of campaign A. For each of users u1-u3, expanded campaign data associated with the user is updated to identify campaign A. The expanded campaign data may be part of each user's profile. For some users, the expanded campaign data may be empty. For other users, the expanded campaign data may already identify one or more content delivery campaigns.

### Content Item Selection Event Using Broadened Campaigns

In an embodiment, a content item selection event involves two sets of content delivery campaigns: (1) a first set that is identified based on match between a user's profile attributes and targeting criteria of each content delivery campaign in the first set and (2) a second set that is identified using audience expansion techniques described herein, including using campaign similarity to identify a set of candidate user-campaign pairs. Both sets of campaigns are identified in response to receiving a content request that is associated with the user (e.g., includes a user identifier). The first set may be identified on-the-fly through one or more indexes that are traversed using one or more profile attributes of the user. Alternatively, each campaign in the first set is associated with the user at campaign creation time. Later in the content item selection event process, a campaign may be filtered out due to one or more factors, such as the campaign being paused or the budget of the campaign being exhausted.

The second set may be periodically determined “offline,” or in the background, regardless of whether a content request is received from the user. For example, each time process 300 is performed relative to a set of attention events, a set of users is identified for each campaign of multiple content delivery campaigns. For each user in the set of users identified for a content delivery campaign, a campaign identifier that identifies the content delivery campaign may be stored in association with the user. In that way, if a content request is received that is associated with (or is initiated by) the user, then any campaign identifiers associated with the user are used to identify the corresponding content delivery campaigns.

Each set of campaigns is treated equally. For example, a separate predicted user interaction rate is generated for each campaign in each set of campaigns. Whichever has the highest predicted user interaction rate is selected as part of the content item selection event. Alternatively, the predicted user interaction rate of a campaign is multiplied by a bid associated with the campaign to generate an effective cost per impression (ecpi). Such a value may be used to rank all the content delivery campaigns identified for the content item selection event.

### Example Process

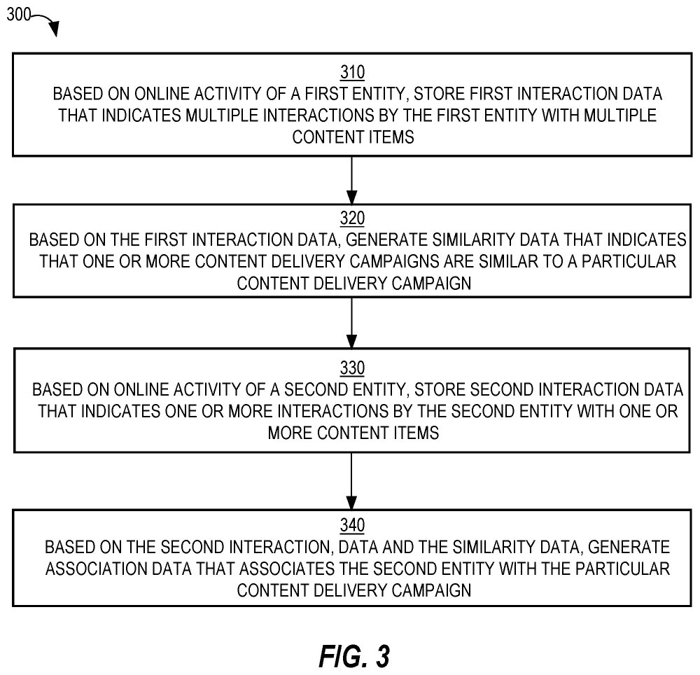

FIG. 3 is a flow diagram that depicts a process 300 for expanding an audience of a content delivery campaign, in an embodiment. Process 300 may be performed by different components or elements of system 200.

At block 310, based on online activity of a first entity (or user), first interaction data is stored. The first interaction data indicates multiple interactions by the first entity with multiple content items. The interactions include an interaction that is based on an amount of time that content within one of the content items was presented to the first entity. The interaction did not involve the first entity selecting the content item. The first interaction data may be part of attention data 210.

At block 320, based on the first interaction data, similarity data is generated that identifies one or more content delivery campaigns that are similar to a particular content delivery campaign. Block 320 may be implemented by campaign similarity identifier 212.

At block 330, based on online activity of a second entity, second interaction data is stored. The second interaction data indicates one or more interactions by the second entity with one or more content items. The one or more content items may be from the one or more content delivery campaigns identified in block 320. Like the first interaction data, the second interaction data may be part of attention data 210.

At block 340, based on the second interaction data and the similarity data, association data is generated that associates the second entity with the particular content delivery campaign. Block 340 may be implemented by user-campaign pair generator 214. Process 300 may further involve adding the association directly to targeting plan 228. Alternatively, process 300 may involve leveraging scoring model 222 to compute feature values associated with the second entity and the particular content delivery campaign and generate a score based on those feature values, and then leveraging reranker 226 to determine whether to add the association to targeting plan 228 based on the score. Additionally, process 300 may also involve using audience expander 218 to generate additional user-campaign pairs using different expansion techniques than through attention data 210 and campaign similarity identifier 212 and using scoring model 222 to generate scores for those additional pairs, which reranker 226 will consider for adding to targeting plan 228.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

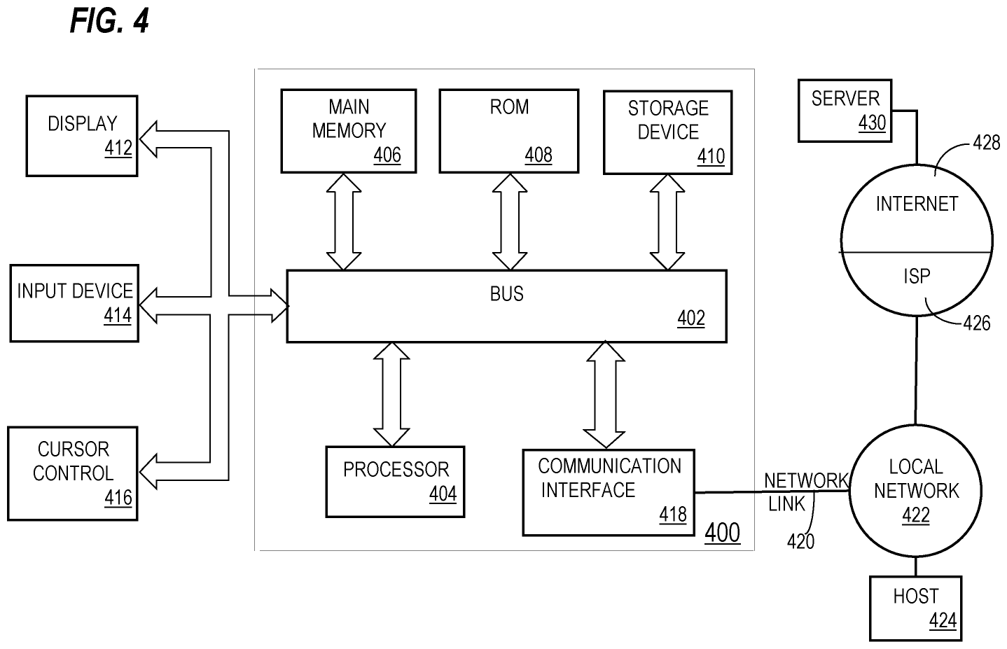

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing first interaction data for a first entity that indicates a plurality of interactions by the first entity with a plurality of content items, wherein the plurality of interactions includes an interaction that is based on an amount of time that content within a content item, of the plurality of content items, was presented to the first entity;
based on the first interaction data, generating similarity data that identifies one or more content delivery campaigns that are similar to a particular content delivery campaign;
storing second interaction data for a second entity that indicates one or more interactions by the second entity with one or more content items;
based on the second interaction data and the similarity data, storing association data that associates the second entity with the particular content delivery campaign;
wherein the method is performed by one or more computing devices.

2. The method of claim 1, further comprising:
in response to receiving a content request initiated by the second entity, identifying, based on a profile of the second entity, a plurality of content delivery campaigns that does not include the particular content delivery campaign, wherein the profile of the second entity does not satisfy one or more targeting criteria of the particular content delivery campaign.

3. The method of claim 1, further comprising:
in response to receiving a content request initiated by the second entity, identifying, based on the association data, the particular content delivery campaign;
causing a particular content item of the particular content delivery campaign to be transmitted to a computing device of the second entity.

4. The method of claim 1, wherein the interaction is viewing a video of the content item for a first period of time or viewing the content item for a second period of time.

5. The method of claim 1, further comprising:
using one or more machine learning techniques to train a scoring model that is based on a plurality of features and that generates scores for entity-campaign pairs;
identifying, for the particular content delivery campaign, a plurality of entities;
using the scoring model to generate a score for each entity in the plurality of entities relative to the particular content delivery campaign;
generating a ranking of the plurality of entities based on the score for each entity in the plurality of entities;
based on the ranking, selecting, for the particular content delivery campaign, a strict subset of the plurality of entities.

6. The method of claim 5, further comprising:
storing third interaction data that indicates a second plurality of interactions by a second plurality of entities with a second plurality of content items, wherein the second plurality of interactions includes interactions that are based on amounts of time that the second plurality of content items were individually presented to the second plurality of entities;
based on the third interaction data, generating a plurality of training instances, each of which corresponds to a particular interaction in the second plurality of interactions and includes a label that is based on the particular interaction.

7. The method of claim 6, wherein a first interaction in the second plurality of interactions corresponds to (a) a video view event that indicates that an entity viewed a video of a first content item in the second plurality of content items for a first period of time that is less than the length of the video or (b) an impression event that indicates that an entity was presented with a second content item for a second period of time.

8. The method of claim 6, wherein:
the plurality of training instances includes a first training instance that corresponds to a first interaction that is based on a first period of time;
the plurality of training instances includes a second training instance that corresponds to a second interaction that is based on a second period of time that is longer than the first period of time;
the method further comprising:
generating a first weight for the first training instance and a second weight, for the second training instance, that is different than the first weight based on the second period of time being longer than the first period of time; or
generating a first label for the first training instance and a second label, for the second training instance, that is different than the first label based on the second period of time being longer than the first period of time.

9. The method of claim 5, wherein the plurality of features includes user features, campaign features, and cross user-campaign features.

10. A method comprising:
storing interaction data that indicates a plurality of interactions by a first plurality of entities with a plurality of content items,
wherein the plurality of interactions includes interactions that are based on an amount of time that a content item in the plurality of content items was presented to an entity in the first plurality of entities;
based on the interaction data, generating a plurality of training instances, each of which corresponds to an interaction in the plurality of interactions and includes a label that is based on the interaction;
using one or more machine learning techniques to train a scoring model that is based on a plurality of features and that generates a score for each entity-campaign pair;
identifying, for a particular content delivery campaign, a second plurality of entities;
using the scoring model to generate a score for each entity in the second plurality of entities relative to the particular content delivery campaign;
generating a ranking of the second plurality of entities based on the score for each entity in the second plurality of entities;
based on the ranking, selecting, for the particular content delivery campaign, a strict subset of the second plurality of entities.

11. The method of claim 10, further comprising:
in response to receiving a content request initiated by a particular entity in the strict subset, identifying the particular content delivery campaign;
causing a particular content item of the particular content delivery campaign to be transmitted to a computing device of the particular entity.

12. One or more storage media storing instructions which, when executed by the one or more processors, cause:
storing first interaction data for a first entity that indicates a plurality of interactions by the first entity with a plurality of content items, wherein the plurality of interactions includes an interaction that is based on an amount of time that content within a content item, of the plurality of content items, was presented to the first entity;
based on the first interaction data, generating similarity data that identifies one or more content delivery campaigns that are similar to a particular content delivery campaign;
storing second interaction data for a second entity that indicates one or more interactions by the second entity with one or more content items;
based on the second interaction data and the similarity data, storing association data that associates the second entity with the particular content delivery campaign.

13. The one or more storage media of claim 12, wherein the instructions, when executed by
the one or more processors, further cause:
in response to receiving a content request initiated by the second entity, identifying, based on a profile of the second entity, a plurality of content delivery campaigns that does not include the particular content delivery campaign, wherein the profile of the second entity does not satisfy one or more targeting criteria of the particular content delivery campaign.

14. The one or more storage media of claim 12, wherein the instructions, when executed by the one or more processors, further cause:
in response to receiving a content request initiated by the second entity, identifying, based on the association data, the particular content delivery campaign;
causing a particular content item of the particular content delivery campaign to be transmitted to a computing device of the second entity.

15. The one or more storage media of claim 12, wherein the interaction is viewing a video of the content item for a first period of time or viewing the content item for a second period of time.

16. The one or more storage media of claim 12, wherein the instructions, when executed by the one or more processors, further cause:
using one or more machine learning techniques to train a scoring model that is based on a plurality of features and that generates scores for entity-campaign pairs;
identifying, for the particular content delivery campaign, a plurality of entities;
using the scoring model to generate a score for each entity in the plurality of entities relative to the particular content delivery campaign;
generating a ranking of the plurality of entities based on the score for each entity in the plurality of entities;
based on the ranking, selecting, for the particular content delivery campaign, a strict subset of the plurality of entities.

17. The one or more storage media of claim 16, wherein the instructions, when executed by the one or more processors, further cause:
storing third interaction data that indicates a second plurality of interactions by a second plurality of entities with a second plurality of content items, wherein the second plurality of interactions includes interactions that are based on amounts of time that the second plurality of content items were individually presented to the second plurality of entities;
based on the third interaction data, generating a plurality of training instances, each of which corresponds to a particular interaction in the second plurality of interactions and includes a label that is based on the particular interaction.

18. The one or more storage media of claim 17, wherein a first interaction in the second plurality of interactions corresponds to (a) a video view event that indicates that an entity viewed a video of a first content item in the second plurality of content items for a first period of time that is less than the length of the video or (b) an impression event that indicates that an entity was presented with a second content item for a second period of time.

19. The one or more storage media of claim 17, wherein:
the plurality of training instances includes a first training instance that corresponds to a first interaction that is based on a first period of time;
the plurality of training instances includes a second training instance that corresponds to a second interaction that is based on a second period of time that is longer than the first period of time;
the instructions, when executed by the one or more processors, further cause:
generating a first weight for the first training instance and a second weight, for the second training instance, that is different than the first weight based on the second period of time being longer than the first period of time; or
generating a first label for the first training instance and a second label, for the second training instance, that is different than the first label based on the second period of time being longer than the first period of time.

20. The one or more storage media of claim 16, wherein the plurality of features includes user features, campaign features, and cross user-campaign features.
